(19) United States
(12) Patent Application Publication
(10) Pub. No.: US 2022/0274067 A1
(43) Pub. Date: Sep. 1, 2022

(54) METHOD FOR SYNTHESIZING HIGH-QUALITY INORGANIC FILM BY MICROWAVE HEATING

(71) Applicant: HUANGSHAN UNIVERSITY, Huangshan City, Anhui Province (CN)

(72) Inventors: Liangqing LI, Huangshan City (CN); Jiajia LI, Huangshan City (CN); Liangsong LI, Huangshan City (CN)

(21) Appl. No.: 17/630,826

(22) PCT Filed: Sep. 22, 2020
(86) PCT No.: PCT/CN2020/116779

§ 371 Date: Jan. 27, 2022

(30) Foreign Application Priority Data
Mar. 30, 2020 (CN) 202010237389.7

(51) Int. Cl. B01D 67/00; B01D 71/02; B01J 19/12

(52) U.S. Cl. CPC B01D 67/0051; B01D 67/0044; B01D 71/028; B01J 19/126; B01D 2323/08

(57) ABSTRACT

The present invention discloses a new method for synthesizing a high-quality inorganic film by microwave heating, which relates to the field of preparation of inorganic materials. The method for synthesizing a high-quality inorganic film by microwave heating in the present invention allows a fine design and control of the temperature increase process during microwave heating, wherein the matrix and the synthesis solution is put into the microwave reactor at first, the temperature interval between the initial temperature and the target temperature of the synthesis solution is then divided into multiple sections, each of which sets a temperature increase rate, and then when the temperature reaches the target temperature after the designed temperature increase process, the synthesis solution reacts for a period of time at the target temperature, finally the high-quality inorganic film can be obtained after the treatment of washing and drying. The inorganic film prepared by the method of the present invention is dense and thin.

### TECHNICAL FIELD

The present invention pertains to the field of preparation of inorganic materials, which relates to a method for synthesis of an inorganic film, in particular provides a method for synthesizing a high-quality inorganic film by microwave heating.

### BACKGROUND

An inorganic film with superior mechanical stability, thermal stability and chemical stability has a wide range of applications in gas separation, liquid separation, gas-liquid separation and catalytic processes.

Compared to traditional heating methods, microwave heating is widely utilized in the synthesis of materials for numerous advantages such as fast heating velocity, uniform heating, high efficiency, environmental friendliness, etc. In the past reports, researchers have synthesized and prepared a variety of inorganic film materials with microwave heating, during which a significant progress has been made. However, the influence of the temperature increase process on the preparation of an inorganic film was ignored in the past. The present technical solution sets a temperature increase interval with multiple sections, wherein a temperature increase rate is set in the respective temperature increase sections, and then the preparation process of the inorganic film can be further regulated through the control of the temperature increase process during microwave heating, so that the preparation of the high-quality inorganic film is more convenient.

### SUMMARY

The purpose of the present invention is to provide a method for synthesizing a high-quality inorganic film by microwave heating, wherein the temperature interval between the initial temperature and the target temperature of the synthesis solution is divided into multiple temperature sections, and a temperature increase rate is set in the respective temperature sections, thereby the temperature is increased at the given temperature increase rate in the respective temperature sections, so that the preparation of the inorganic film is precisely controlled in the process of microwave heating to make the inorganic film prepared denser and thinner.

The purpose of the invention is achieved by the following technical solution:

The method for synthesizing the high-quality inorganic film by microwave heating includes particular steps as follows:

Step 1: Preparations for microwave heating putting a matrix material into a microwave reactor and then adding the reaction synthesis solution to immerse the matrix material;

Step 2: Temperature increase process during microwave heating diving the temperature interval between the initial temperature and the target temperature of the synthesis solution into multiple temperature sections, and setting a temperature increase rate in the respective temperature sections, thereby the temperature is increased at the given temperature increase rate in the respective temperature sections;

Step 3: Reaction during microwave heating maintaining the synthesis solution at the target temperature to react for a period of time after reaching the target temperature;

Step 4: Post-treatment of sample

taking out the matrix sample after reaction and rinsing it with clean water until it is clean, and obtaining the high-quality inorganic film after drying.

In the aforementioned technical solution of the present application, the shape of the matrix material in Step 1 may be flat-plate, tubular, disk-like, cubic or capillary-like.

In the aforementioned technical solution of the present application, the matrix material in Step 1 may be inorganic, organic or composite material.

In the aforementioned technical solution of the present application, the matrix in Step 1 may be performed with pretreatment including pre-coating with crystal nuclei, functionalization, modification or other pretreatment.

In the aforementioned technical solution of the present application, the number of the temperature sections of the temperature interval in the temperature increase process during microwave heating in Step 2 is in the range of 1-30, preferably in the range of 2-15.

In the aforementioned technical solution of the present application, the temperature increase rate of the temperature section in the temperature increase process during microwave heating in Step 2 is in the range of 0.5-200° C./min, preferably in the range of 2-100° C./min.

In the aforementioned technical solution of the present application, the target temperature in the reaction during microwave heating in Step 3 is in the range of 50−250° C., preferably in the range of 60−200° C.

In the aforementioned technical solution of the present application, the period of time in the reaction during microwave heating in Step 3 is in the range of 1-500 min, preferably in the range of 5-250 min.

In the aforementioned technical solution of the present application, the inorganic film in Step 4 may be a molecular sieve film, a ceramic film, a metal film, a metal oxide film or other new inorganic film, preferably a molecular sieve film.

In the technical solution of the present application, the inorganic film prepared can be used for gas separation, liquid separation, gas-liquid separation and a catalytic membrane reactor.

In the technical solution of the present application, the control of the temperature increase process can facilitate the preparation of the high-quality inorganic film and can further shorten the synthesis time at the target temperature.

### BRIEF DESCRIPTION OF THE DRAWINGS

FIG. 1 illustrates an SEM image of the surface of an alumina tube in Embodiment 1;

FIG. 2 illustrates an SEM image of the cross section of an alumina tube in Embodiment 1;

FIG. 3 illustrates an SEM image of the surface of a mordenite molecular film prepared in Embodiment 1;

FIG. 4 illustrates an SEM image of the cross section of a mordenite molecular film prepared in Embodiment 1;

FIG. 5 illustrates an SEM image of the surface of a stainless steel tube in

Embodiment 2;

FIG. 6 illustrates an SEM image of the surface of a ZSM-5 molecular sieve film in Embodiment 2.

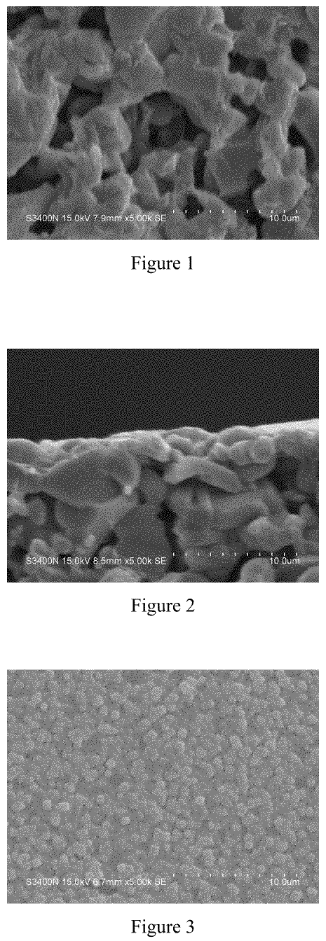

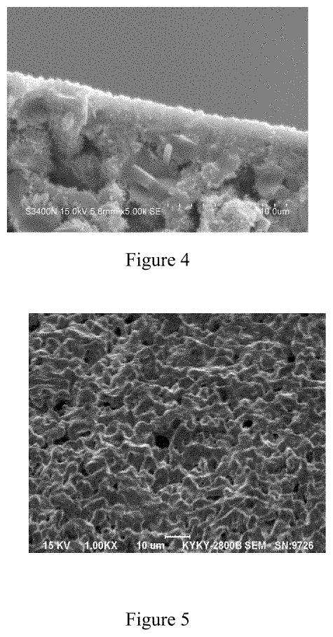

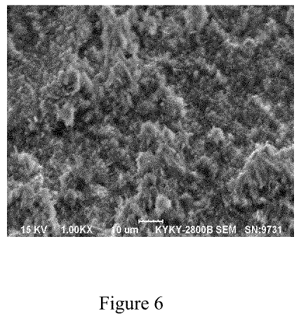

### DETAILED DESCRIPTION

It will be appreciated that the non-limiting embodiments described hereinafter can enable those skilled in the art to understand this invention more thoroughly but are NOT intended to be in any way of limiting. In the following embodiments, unless otherwise noted, the experimental methods used are all conventional methods, and the materials and reagents used can be purchased from biological or chemical companies. The present invention is further illustrated in combination with the embodiments hereinafter.

### Embodiment 1

With an alumina tube as the matrix, which is 12 mm in outer diameter, 8 mm in inner diameter, 50 mm in length, and 2-3 μm in pore diameter, a mordenite molecular sieve film is prepared on the outer surface of the tube:

(1) Mordenite molecular sieve film crystal nuclei are initially introduced on the matrix surface with a hot dipping method.

(2) A synthesis solution is formulated with mole ratio of Sift:0.52 NaOH:0.06 Al₂O₃:125 H₂O:0.3 NaF:first, NaOH and silicon source are added to deionized water in which they are dissolved under stirring, and then aluminum source is added, followed by NaF, and the synthesis solution of the mordenite molecular sieve film is obtained after stirring for 2 hours at room temperature.

(3) The treated matrix in (1) is put vertically into the microwave reactor, and then the synthesis solution in (2) is added slowly to immerse the matrix.

(4) The initial temperature of the synthesis solution is 25° C. and the target temperature thereof is 175° C., wherein the temperature increase interval is divided into 2 sections, of which the first section has the temperature range of 25−100° C. and its temperature increase rate is set to be 7.5° C./min, and the second section has the temperature range of 100−175° C. and its temperature increase rate is set to be 15° C./min, and the reaction duration is set to be 60 min at the target temperature of 175° C.

(5) After the microwave heating in (4), the matrix is taken out, washed and dried, finally the high-quality mordenite molecular sieve film is obtained on the matrix surface. The mordenite molecular sieve film has a dense layer, a thickness of 1.5 μm and a morphology as shown in the accompanying surface SEM image and the cross sectional SEM image.

The mordenite film is used for pervaporation dehydration of 90 wt % acetic acid, exhibiting an excellent property of acetic acid dehydration separation, with the permeate flux being 1.42 kg/(m2h) and the corresponding separation factor being above 10000.

### Embodiment 2

With a stainless steel tube as the matrix, a ZSM-5 molecular sieve film is prepared in the tube outer surface.

(1) ZSM-5 molecular sieve film crystal nuclei are initially introduced on the matrix surface with a hot dipping method.

(2) A synthesis solution is formulated with the mole ratio of SiO₂:0.34 NaOH: 0.05 Al₂O₃:45 H₂O:0.9 NaF:first, NaOH and silicon source are added to deionized water in which they are dissolved under stirring, and then aluminum source is added, followed by NaF, and the synthesis solution of the ZSM-5 molecular sieve film is obtained after stirring for 2 hours at room temperature.

(3) The treated matrix in (1) is put vertically into the microwave reactor, and then the synthesis solution in (2) is added slowly to immerse the matrix.

(4) The initial temperature of the synthesis solution is 25° C. and the target temperature thereof is 170° C., wherein the temperature increase interval is divided into 3 sections, of which the first section has the temperature range of 25−60° C. and its temperature increase rate is set to be 5° C./min, the second interval has the temperature range of 60−100° C. and its temperature increase rate is set to be 10° C./min, and the third section has the temperature range of 100−170° C. and its temperature increase rate is set to be 25° C./min, and the reaction duration is set to be 40 min at the target temperature of 170° C.

(5) After the microwave heating in (4), the matrix is taken out, washed and dried, finally the high-quality ZSM-5 molecular sieve film is obtained on the matrix surface.

The stainless steel tube has parameters including an outer diameter of 11 mm, an inner diameter of 9 mm, a length of 50 mm, a pore diameter of 2 μm, and the film is dense without obvious apertures and gaps.

The ZSM-5 molecular sieve film is used for pervaporation dehydration of 90 wt % acetic acid, exhibiting an excellent property of acetic acid dehydration separation, with the permeate flux being 1.87 kg/(m2h) and the corresponding separation factor being above 10000.

1. A method for synthesizing a high-quality inorganic film by microwave heating, characterized in that, in the reaction and synthesis process with microwave heating, a matrix material is put into a microwave reactor at first, and a reaction synthesis solution is added to immerse the matrix material, the temperature interval between the initial temperature and the target temperature of the synthesis solution is divided into multiple temperature sections, each of which sets a temperature increase rate, and then when the temperature reaches the target temperature after multiple temperature sections, the synthesis solution reacts for a period of time at the target temperature, finally the high-quality inorganic film is obtained after the treatment of washing and drying.

2. The method for synthesizing the high-quality inorganic film by microwave heating according to claim 1, characterized in that, the method comprises particular steps as follows:
Step 1: Preparations for microwave heating
putting the matrix material into a microwave reactor and then adding the reaction synthesis solution to immerse the matrix material;
Step 2: Temperature increase process during microwave heating
diving the temperature interval between the initial temperature and the target temperature of the synthesis solution into multiple temperature sections, and setting a temperature increase rate in the respective temperature sections, thereby the temperature is increased at the given temperature increase rate in the respective temperature sections;
Step 3: Reaction during microwave heating
maintaining the synthesis solution at the target temperature to react for a period of time after reaching the target temperature;
Step 4: Post-treatment of sample
taking out the matrix sample after reaction and rinsing it with clean water until it is clean, and obtaining the high-quality inorganic film is obtained after drying.

3. The method for synthesizing the high-quality inorganic film by microwave heating according to claim 2, characterized in that, the shape of the matrix material in Step 1 is flat-plate, tubular, disk-like, cubic or capillary-like.

4. The method for synthesizing the high-quality inorganic film by microwave heating according to claim 2, characterized in that, the matrix material in Step 1 is inorganic, organic or composite material.

5. The method for synthesizing the high-quality inorganic film by microwave heating according to claim 2, characterized in that, the matrix in Step 1 is performed with pretreatment including pre-coating with crystal nuclei and functionalization.

6. The method for synthesizing the high-quality inorganic film by microwave heating according to claim 2, characterized in that, the number of the temperature sections of the temperature interval in the temperature increase process during microwave heating in Step 2 is in the range of 1-30.

7. The method for synthesizing the high-quality inorganic film by microwave heating according to claim 2, characterized in that, the temperature increase rate of the temperature sections in the temperature increase process during microwave heating in Step 2 is in the range of 0.5-200° C./min.

8. The method for synthesizing the high-quality inorganic film by microwave heating according to claim 2, characterized in that, the target temperature in the reaction during microwave heating in Step 3 is in the range of 50−250° C.

9. The method for synthesizing the high-quality inorganic film by microwave heating according to claim 2, characterized in that, the period of time in the reaction during microwave heating in Step 3 is in the range of 1-500 min.

10. The method for synthesizing the high-quality inorganic film by microwave heating according to claim 2, characterized in that, the inorganic film in Step 4 includes a molecular sieve film, a ceramic film, a metal film and a metal oxide film.
